(19) United States
(12) Patent Application Publication
(10) Pub. No.: US 2014/0157155 A1
(43) Pub. Date: Jun. 5, 2014

(54) IMPLEMENTATION METHOD OF USER INTERFACE AND DEVICE USING SAME METHOD

(71) Applicants: Seong Yong Lim, Daejeon-si (KR); Ji Hun Cha, Daejeon-si (KR); In Jae Lee, Daejeon-si (KR); Sang Hyun Park, Daejeon-si (KR); Young Kwon Lim, Goyang-si Gyeonggi-do (KR)

(72) Inventors: Seong Yong Lim, Daejeon-si (KR); Ji Hun Cha, Daejeon-si (KR); In Jae Lee, Daejeon-si (KR); Sang Hyun Park, Daejeon-si (KR); Young Kwon Lim, Goyang-si Gyeonggi-do (KR)

(73) Assignee: Electronics and Telecommunications Research Institute, Daejeon-si (KR)

(21) Appl. No.: 14/232,155

(22) PCT Filed: Jul. 11, 2012
(86) PCT No.: PCT/KR2012/005484

§ 371 Date: Jan. 10, 2014

(30) Foreign Application Priority Data
Jul. 12, 2011 (KR) 10-2011-0069106
May 17, 2012 (KR) 10-2012-0052257

(51) Int. Cl. G06F 3/0484

(52) U.S. Cl. CPC G06F 3/0484
USPC 715/764

(57) ABSTRACT

Disclosed are an implementation method of a user interface and a device using the same method. The implementation method of a user interface comprises a step for receiving AUI (Advanced User Interaction) pattern information and a step for interpreting the inputted AUI pattern information based on a predefined interface. Therefore, a preset AUI pattern generated in a user interaction device is implemented in various applications by defining the implementation method of an interface between a user interaction device and a scene description.

### BACKGROUND OF THE INVENTION

1. Field of the invention

The present invention relates to a method of implementing a user interface and a device using the method.

2. Related Art

User interaction devices have been developed in recent years. In addition to the devices for interaction with a user such as a mouse, a keyboard, a touchpad, a touch screen, and voice recognition in related art, recently, new types of user interaction devices such as a multi-touchpad and a motion sensing remote controller have been introduced.

Although multimedia technologies have been studied to provide application technologies for using the developed user interaction devices, most of the present user interaction standards are concentrated on basic interaction devices such as pointing or keying which is used in the existing electronic products.

There was no user interaction standard for the developed new types of user interaction devices such as the multi-touchpad and the motion sensing remote controller. Further, there was also no user interaction standard that can be applied to both of the basic interaction devices such as the existing pointing or keying and the developed new types of user interaction devices.

### SUMMARY OF THE INVENTION

The present invention has been made in an effort to provide a method of implementing an advanced user interaction interface (AUI).

Further, the present invention provides a device that performs the method of implementing an advanced user interaction interface (AUI).

A method of implementing a user interface according to an aspect of the present invention for achieving the object of the present invention may include: receiving AUI (Advanced User Interaction) pattern information; and analyzing the inputted AUI pattern information on the basis of a predefined interface. The predefined interface may be an interface that defines at least one piece of pattern information of Point, Line, Rect, Arc, Circle, SymbolicPattern, TouchPattern, and HandPosture. The predefined interface may be an interface in which at least one of the pattern information is selectively used as pattern information of a widget manager, as predetermined predefined pattern information. The predefined interface may be an interface in which at least one of the pattern information is selectively used a W3C (World Wide Web Consortium) application, as predetermined predefined pattern information.

A method of implementing a user interface according to another aspect of the present invention for achieving the object of the present invention may include: receiving input information from a Scene Description; and analyzing the input information provided from the Scene Description on the basis of a predefined interface, and inputting the analyzed input information to a data format converter. The predefined interface may be an interface that defines at least one piece of pattern information of Point, Line, Rect, Arc, Circle, SymbolicPattern, TouchPattern, and HandPosture. The predefined interface may be an interface in which at least one of the pattern information is selectively used as pattern information of a widget manager, as predetermined predefined pattern information. The predefined interface may be an interface in which at least one of the pattern information is selectively used a W3C (World Wide Web Consortium) application, as predetermined predefined pattern information.

A user interface device according to another aspect of the present invention for achieving the object of the present invention may include: a data format converter that generates AUI (Advanced User Interaction) pattern information; and an interface unit that analyzes the AUI (Advanced User Interaction) pattern information created through the data format converter on the basis of a predefined interface. The interface unit may be an interface unit that defines at least one piece of pattern information of Point, Line, Rect, Arc, Circle, SymbolicPattern, TouchPattern, and HandPosture. The interface unit may be an interface unit in which at least one of the pattern information is selectively used as pattern information of a widget manager, as predetermined predefined pattern information. The interface unit may be an interface unit in which at least one of the pattern information is selectively used a W3C (World Wide Web Consortium) application, as predetermined predefined pattern information.

As described above, according to the method of implementing a user interface according to an exemplary embodiment of the present invention and a device using the method, by defining a method of implementing an interface between a user interaction device and a Scene Description, it is possible to allow a predetermined AUI (Advanced User Interaction) pattern generated by the user interaction device to be applied to various applications.

### BRIEF DESCRIPTION OF THE DRAWINGS

FIG. 1 is a conceptual diagram showing a high-level view between an MPEG-U(ISO/IEC 2007) and an MPEG-V(ISO/IEC 2005) according to an exemplary embodiment of the present invention.

FIG. 2 is a flowchart showing a pattern information analysis method in an MPEG-U Part 1 according to an exemplary embodiment of the present invention.

FIG. 3 is a conceptual diagram showing the motion between a widget manager and a physical device according to an exemplary embodiment of the present invention.

### DESCRIPTION OF EXEMPLARY EMBODIMENTS

Hereinafter, exemplary embodiments of the present invention will be described in detail with reference to the accompanying drawings. In describing exemplary embodiments of the present invention, well-known functions or constructions will not be described in detail since they may unnecessarily obscure the understanding of the present invention.

It is to be understood that when one element is referred to as being “connected to” or “coupled to” another element, it may be connected directly to or coupled directly to another element or be connected to or coupled to another element, having the other element intervening therebetween. Further, in the present specification, in the case of describing “including” a specific component, it is to be understood that additional components other than a corresponding component are not excluded, but may be included in exemplary embodiments or the technical scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention.

In addition, components described in exemplary embodiments of the present invention are independently shown only in order to indicate that they perform different characteristic functions. Therefore, the components that are independently shown do not mean that each of the components may not be implemented as one hardware or software. That is, each of the components is divided and included for convenience of explanation, a plurality of components of the components may be combined with each other to thereby be operated as one component or one component may be divided into a plurality components to thereby perform the function as the plurality of components, which are included in the scope of the present invention as long as it departs from essential characteristics of the present invention.

In addition, some of components may not be indispensable components performing essential functions of the present invention, but be selective components improving only performance thereof. The present invention may also be implemented by including the indispensabley components except for the components only for improving performance, and the structure including only the indispensable components except for the components only for improving performance is also included in the scope of the present invention.

The ISO/IEC 2007 standard (MPEG-U) is a standard for an Information Technology-Rich Media User Interface and is being standardized for three parts divided by a Part 1:Widget, a Part 2:Advanced user interaction(AUI) interfaced, and a Part 3:Conformance and reference software.

The widget is a tool that allows expanded communication and may be defined as follows.

Widget: self-contained entity, with extensive communication capabilities, within a Rich Media User Interface; composed of a Manifest and associated Resources, including Scene Descriptions for the Full and Simplified Representations and Context Information.

An AUI (Advanced User Interface) is a device for providing a medium for transmitting/receiving the information on an advanced interaction device (for example, Motion Sensing remote controller, multi-touch Device).

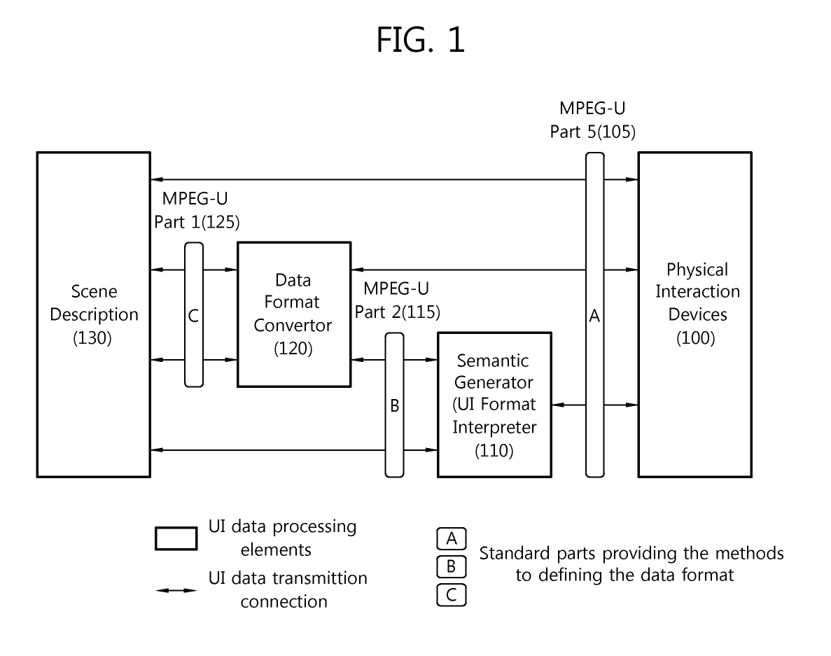

FIG. 1 is a conceptual diagram showing a high-level view between an MPEG-U(ISO/IEC 2007) and an MPEG-V(ISO/IEC 2005) according to an exemplary embodiment of the present invention.

Referring to FIG. 1, an MPEG-V part 5 105 may be used as a description tool for information that is inputted to actual physical interaction devices 100 or may be used as a description tool for transmitting information that is outputted from the physical interaction devices 100 to a data format converter 120 or a semantic generator (UI format interpreter) 110, which will be described below.

The data format converter 120 may perform data conversion on physical interaction device data analyzed by the MPEG-V part 5 such that the data can be applied to a widget that is the MPEG-U part 1 125.

The semantic generator (UI Format Interpreter) 110 may create a sentence element or perform UI (User Interface) format to the physical interaction device data analyzed by the MPEG-V part 5 such that the data can be applied to an AUI that is the MPEG-U part 2 115.

The MPEG-U Part 2 115 may function as an interface between semantic generator (UI Format Interpreter) 110 and the data format converter 120 or a scene description 130.

The sentence information or the UI information, which is created or analyzed by the semantic generator (UI Format Interpreter) 110, respectively, may be analyzed by the MPEG-U Part 2 115 and inputted to the scene description 130 or the data format converter 120.

The MPEG-U part 1 125 defines a method of performing widget management (widget packing and communication and lifecycle management) on the basis of the data converted by the data format converter 120.

The scene description 130 may be defined as follows.

A scene description is a self-contained living entity composed of video, audio, 2D graphics objects, and animations. For example, the scene description may be a widget or a W3C application.

Referring to FIG. 1, data instances created by the MPEG-U part 2 115 may be transmitted by a widget communication method according to the MPEG-U part 1 125. According to an exemplary embodiment of the present invention, the scene description 130 may be provided with the event of an AUI pattern even without the information on the AUI device on the basis of an input AUI pattern value.

A. URN of a Predetermined Message Interface

The following is a table showing the URN (Uniform Resource Name) of the predetermined message interface.

TABLE 1

<mw:interface type=“urn:mpeg:mpegu:schema:widgets:aui:2011”>
<!—
Detail description of interfaces to be transpoted
-->
</mw:interface>

Referring to FIG. 1, a URN for the message interface of the AUI pattern information is newly defined and used for a widget manager, using a URN, “urn:mpeg:mpegu:schema:widget:aui:2100”.

The following Table 2 shows an input interface.

TABLE 2
<messageIn name=“PointType”>
<input name=“captured time stamp” scriptParamType=“number”/>
<input name=“x” scriptParamType=“number”/>
<input name=“y” scriptParamType=“number”/>
<input name=“z” scriptParamType=“number”/>
</messageIn>
<messageIn name=“LineType”>
<input name=“captured time stamp” scriptParamType=“number”/>
<input name=“first position X” scriptParamType=“number”/>
<input name=“first positionY” scriptParamType=“number”/>
<input name=“first positionZ” scriptParamType=“number”/>
<input name=“secondPositionX” scriptParamType=“number”/>
<input name=“secondPositionY” scriptParamType=“number”/>
<input name=“secondPositionZ” scriptParamType=“number”/>
<input name=“starting time stamp” scriptParamType=“number”/>
<input name=“average velocity” scriptParamType=“number” />
<input name=“max acceleration” scriptParamType=“number” />
</messageIn>
<messageIn name=“Rectype”>
<input name=“captured time stamp” scriptParamType=“number”/>
<input name=“topLeftPositionX” scriptParamType=“number”/>
<input name=“topLeftPositionY” scriptParamType=“number”/>
<input name=“topLeftPositionZ” scriptParamType=“number”/>
<input name=“bottomRightPositionX” scriptParamType=“number”/>
<input name=“bottomRightPositionY” scriptParamType=“number”/>
<input name=“bottomRightPositionZ” scriptParamType=“number”/>
<input name=“topRightPositionX” scriptParamType=“number”/>
<input name=“topRightPositionY” scriptParamType=“number”/>
<input name=“topRightPositionZ” scriptParamType=“number”/>
<input name=“bottomLeftPositionX” scriptParamType=“number”/>
<input name=“bottomLeftPositionY” scriptParamType=“number”/>
<input name=“bottomLeftPositionZ” scriptParamType=“number”/>
<input name=“first time stamp” scriptParamType=“number” />
<input name=“second time stamp” scriptParamType=“number” />
<input name=“thirdimeStamp” scriptParamType=“number” />
<input name=“fourth time stamp” scriptParamType=“number” />
</messageIn>
<messageIn name=“ArcType”>
<input name=“captured time stamp” scriptParamType=“number”/>
<input name=“first position X” scriptParamType=“number”/>
<input name=“first positionY” scriptParamType=“number”/>
<input name=“first positionZ” scriptParamType=“number”/>
<input name=“secondPositionX” scriptParamType=“number”/>
<input name=“secondPositionY” scriptParamType=“number”/>
<input name=“secondPositionZ” scriptParamType=“number”/>
<input name=“centerPositionX” scriptParamType=“number”/>
<input name=“centerPositionY” scriptParamType=“number”/>
<input name=“centerPositionZ” scriptParamType=“number”/>
<input name=“starting time stamp” scriptParamType=“number” />
<input name=“ averageAngularVelocity” scriptParamType=“number” />
<input name=“maxAngularAcceleration” scriptParamType=“number” />
</messageIn>
<messageIn name=“CircleType”>
<input name=“captured time stamp” scriptParamType=“number”/>
<input name=“centerPositionX” scriptParamType=“number”/>
<input name=“centerPositionY” scriptParamType=“number”/>
<input name=“centerPositionZ” scriptParamType=“number”/>
<input name=“radius” scriptParamType=“number”/>
<input name=“starting time stamp” scriptParamType=“number” />
<input name=“ averageAngularVelocity” scriptParamType=“number” />
<input name=“maxAngularAcceleration” scriptParamType=“number” />
</messageIn>
<messageIn name=“SymbolicPatternType”>
<input name=“captured time stamp” scriptParamType=“number”/>
<input name=“PositionX” scriptParamType=“number”/>
<input name=“PositionY” scriptParamType=“number”/>
<input name=“PositionZ” scriptParamType=“number”/>
<input name=“size” scriptParamType=“number”/>
<input name=“symbolType” scriptParamType=“string” />
</messageIn>
<messageIn name=“TouchPatternType”>
<input name=“captured time stamp” scriptParamType=“number”/>
<input name=“PositionX” scriptParamType=“number”/>
<input name=“PositionY” scriptParamType=“number”/>
<input name=“PositionZ” scriptParamType=“number”/>
<input name=“touchType” scriptParamType=“string” />
<input name=“value” scriptParamType=“number” />
</messageIn>
<messageIn name=“HandPostureType”>
<input name=“captured time stamp” scriptParamType=“number”/>
<input name=“PositionX” scriptParamType=“number”/>
<input name=“PositionY” scriptParamType=“number”/>
<input name=“PositionZ” scriptParamType=“number”/>
<input name=“postureType” scriptParamType=“string”/>
<input name=“handSide” scriptParamType=“string” />
</messageIn>

Various pieces of pattern information and the information constituting the pattern information are defined in Table 2.

(1) A Point may be defined as the first pattern information. The Point may indicate a two-dimensional or a three-dimensional geometric point in Euclidean space. As the information included in the Point, the capturedTimeStamp, userId, x, y, and z may be used.

The capturedTimeStamp shows the time information when the AUI pattern is recognized and may be generally shown by millisecond from 0 hour 0 minute on Jan. 1, 1970.

The userId may show the user information.

The x, y, and z may be input values that are used to show the position information of a point.

(2) A Line may be defined as another message interface. The Line is pattern information showing a pattern connecting two points. The position information at both ends of a straight line, the time information when the straight line selectively starts, and velocity and acceleration information may be used to show the pattern information.

As the information expressing the Line, the capturedTimeStamp, userId, firstPositionX, firstPositionY, firstPositionZ, secondPositonX, secondPositonY, secondPositonZ, startingTimestamp, averageVelocity, and maxAcceleration may be used.

The capturedTimeStamp and userId have the same definition as those in the point described above.

The firstPositionX, firstPositionY, and firstPositionZ may be position of the first end point and the secondPositonX, secondPositonY, and secondPositonZ may be the position of the second end point.

The startingTimestamp shows the information on when the line started, the averageVelocity shows the average velocity information while the line pattern is created, and the maxAcceleration shows the maximum acceleration information while the line pattern is created.

(3) A Rect may be defined as another pattern information. The Rect is a rectangular pattern constituting the position of the corners of a rectangle and may be expressed based on the basis of the positions of two opposite corners or the positions of four opposite corners.

The capturedTimeStamp, userId, TopLeftPosition, BottomRightPosition, TopRightPosition, BottomLeftPosition, firstTimeStamp, secondTimeStamp, thirdTimeStamp, and fourthTimeStamp may be used as the information for expressing the Rect.

The TopLeftPosition shows the information on the position of the upper left corner of the rectangle, the BottomRightPosition shows the information on the lower right corner of the rectangle, the TopRightPosition shows the information on the position of the upper right corner of the rectangle, and the BottomLeftPosition shows the information on the lower left position of the rectangle.

The firstTimeStamp shows the time information when the first corner was created, when the rectangular pattern is created, the secondTimeStamp shows the time information when the second corner was created, when the rectangular pattern is created, the thirdTimeStamp shows the time information when the third corner was created, when the rectangular pattern is created, and the fourthTimeStamp shows the time information when the fourth corner was created, when the rectangular pattern is created.

(4) An Arc may be defined as another pattern information. The Arc shows an arc pattern and may include the position information on the start and end points of an arc, the position information on the center of a circle, an angular velocity, an angular acceleration, and the time information when an arc pattern started to be drawn.

The capturedTimeStamp, userId, firstPositionX, firstPositionY firstPositionZ, secondPositionX, secondPositionY, secondPositionZ, centerPositionX, centerPositionY, centerPositionZ, startingTimeStamp, averageAngularVelocity may be included as the information for expressing the Arc.

The firstPositionX, firstPositionY, and firstPositionZ are the information showing the start position of an arc and expressed on the basis of two-dimensional or three-dimensional position information.

The secondPositionX, secondPositionY, and secondPositionZ are the information showing the start position of an arc and expressed on the basis of two-dimensional or three-dimensional position information.

The centerPositionX, centerPositionY, and centerPositionZ are the information showing the start position of an arc and expressed on the basis of two-dimensional or three-dimensional position information.

The startingTimeStamp may show the information showing the time information when the arc pattern started to be created and the averageAngularVelocity may show the average angular velocity information while the arc pattern is formed.

(5) A Circle may be defined as another pattern information. The Circle shows a circle pattern and may be expressed on the basis of the center position information of a circle, the radius information, and the average angular acceleration information.

The centerPositionX, centerPositionY, centerPositionZ, startingTimeStamp, and averageAngularVelocity may be included as the information for showing the Circle.

The centerPositionX, centerPositionY, and centerPositionZ are information for showing the center position of a circle and may show the center position of a circle on a two-dimensional or three-dimensional plane.

The startingTimeStamp may show the information showing the time information when the circle pattern started to be created and the averageAngularVelocity may show the average angular velocity information while the circle pattern is formed.

(6) A SymbolicPattern may be defined as another pattern information. The SymbolicPattern may recognize the action information of a user as a new symbol on the basis of the size and position of the action information.

The capturedTimeStamp, userId, PositionX, PositionY, PositionZ, and size, symbolType may be used as the information for showing the SymbolicPattern.

The PositionX, PositionY, and PositionZ are the position information where the SymbolicPattern is recognized, the size is the size information of the SymbolicPattern, and the symboltype may be used as information that shows which kind the symbolic pattern is.

(7) A TouchPattern may be defined as another pattern information. The TouchPattern is pattern information of a touch of a user and may recognize the action information of the user as a new touch pattern on the basis of the input continuation time of the action information, the number of times of input, the input movement direction, and the rotation direction.

The capturedTimeStamp, userId, Position X, Position Y, Position Z, touchtype, and value may be used as the information for expressing the TouchPattern.

The Position X, Position Y, and Position Z may show the position information where a touch is generated, the touchType is the information on the type of the touch, and the value may be used as the information for storing additional necessary information for the kind of the touch pattern.

(8) A HandPosture may be defined as another pattern information. The HandPosture explains the pose of the user's hand and the Posture is an element that means the pose type of the hand.

The capturedTimeStamp, userId, Position X, Position Y, Position Z, postureType, and chirality may be used as the information for expressing the HandPosture.

The Position X, Position Y, and Position Z may show the position information where the Posture of the hand is generated, the postureType means the pose type information of the user's hand, and the chirality may show whether the user's hand is the left hand or the right hand.

(8) A HandGesture may be defined as another pattern information. The HandGesture shows the information of the action of the user's hand. The capturedTimeStamp, userId, gesturetype, and chirality may be used as the information for expressing the HandGesture.

The Position X, Position Y, and Position Z may show the position information where the gesture of the hand is generated, the gestureType means the action type information of the user's hand, and the chirality may show whether the user's hand is the left hand or the right hand.

The patter information described above in Table 2 may be selectively used. That is, at least one piece of pattern information of the pieces of pattern information may be selectively used as the pattern information of the widget manager.

That is, the message interface of the AUI pattern described above in Table 2 may be optional and only some of the message interface of the AUI pattern may be used in actual implementation.

An AUI pattern according to another exemplary embodiment of the present invention may also be used for a W3C application. For example, an html page may also be implemented on the basis of a geometric pattern, a touch pattern, and a symbol pattern of a user's motion.

In an exemplary embodiment of the present invention, an IDL (Interface Definition Language) even definition for communicating with the W3C widget is renewed.

B. IDL (Interface Definition Language) of AUI Patterns

Hereinafter, an event type, sentence elements, and the definition of the sentence elements for implementing an interface for a W3C (World Wide Web Consortium) application are proposed as follows.

TABLE 3

interface MPEGAUIEvent : UIEvent {
typedef float fVectorType[3];
typedef sequence<fVectorType> fVectorListType;
typedef sequence<float> floatListType;

readonly attribute unsigned long long capturedTimeStamp;

readonly attribute string userId;

readonly attribute float averageVelocity;
readonly attribute float maxAcceleration;
readonly attribute string sType;

readonly attribute string chirality;
readonly attribute float fValue;

readonly attribute fVectorListType positions;

readonly attribute floatListType timeStamps;
};

TABLE 4

| | Context Info | | | |
|---|---|---|---|---|
| Event Type | Syntax | Sematics | Bubbles | Cancelable |
| Point | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D value of a | | |
| | | position at which the event occurred | | |
| | | relative to the origin of the screen | | |
| | | coordinate system | | |
| Line | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D values of the first | | |
| | | and second positions in a line at which | | |
| | | the event occurred relative to the origin | | |
| | | of the screen coordinate system | | |
| | timeStamps | Describes the starting time (in | | |
| | | milliseconds relative to the epoch) at | | |
| | | which a user interaction was started. | | |
| | averageVelocity | Describes the value of average velocity | | |
| | | while creating a line pattern. | | |
| | maxAcceleration | Describes the value of maximum | | |
| | | acceleration while creating a line pattern. | | |
| Rect | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D values of the | | |
| | | corner positions in a rectangular at | | |
| | | which the event occurred relative to the | | |
| | | origin of the screen coordinate system | | |
| | timeStamps | Describes the time stamps (in | | |
| | | milliseconds relative to the epoch) at | | |
| | | which corners were constructed | | |
| Arc | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D values of the | | |
| | | first, second and center positions in an | | |
| | | arc at which the event occurred relative | | |
| | | to the origin of the screen coordinate | | |
| | | system | | |
| | timeStamps | Describes the starting time (in | | |
| | | milliseconds relative to the epoch) at | | |
| | | which a user interaction was started. | | |
| | averageVelocity | Describes the value of average angular | | |
| | | velocity while creating an arc pattern. | | |
| Circle | capturedTimeStamp | Describes the time (in milliseconds | Yes | Yes |
| | | relative to the epoch) at which a user | | |
| | | interaction was captured | | |
| | positions | Describes the 2D or 3D value of the | | |
| | | center position in an arc at which the | | |
| | | event occurred relative to the origin of | | |
| | | the screen coordinate system | | |
| | timeStamps | Describes the starting time (in | | |
| | | milliseconds relative to the epoch) at | | |
| | | which a user interaction was started. | | |
| | averageVelocity | Describes the value of average angular | | |
| | | velocity while creating an arc pattern. | | |
| | fValue | Describes the radius value of a circle | | |
| | | pattern relative to the screen coordinate | | |
| | | system | | |
| TouchPattern | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D value of the | | |
| | | position in a touch pattern at which the | | |
| | | event occurred relative to the origin of | | |
| | | the screen coordinate system | | |
| | sType | Describes the label of a symbolic touch | | |
| | | pattern as a reference to a classification | | |
| | | scheme term provided by TouchTypeCS. | | |
| | fValue | Describes the value that a touch pattern | | |
| | | needs. It means that the meaning of this | | |
| | | attribute is dependent on the touch | | |
| | | pattern as described in 5.4.3. | | |
| SymbolicPattern | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D value of the | | |
| | | center position in a symbolic pattern at | | |
| | | which the event occurred relative to the | | |
| | | origin of the screen coordinate system | | |
| | sType | Describes the label of a symbolic pattern | | |
| | | as a reference to a classification scheme | | |
| | | term provided by SymbolTypeCS. | | |
| | fValue | Describes the size of a symbolic pattern | | |
| | | relative to the screen coordinate system | | |
| HandPosture | capturedTimeStamp | Describes the time (in milliseconds | Yes | Yes |
| | | relative to the epoch) at which a user | | |
| | | interaction was captured | | |
| | userId | Describes an index referencing the user | | |
| | | who is generating AUI patterns. | | |
| | positions | Describes the 2D or 3D value of the | | |
| | | position in a hand posture pattern at | | |
| | | which the event occurred relative to the | | |
| | | origin of the screen coordinate system | | |
| | sType | Describes the label of a hand posture | | |
| | | pattern as a reference to a classification | | |
| | | scheme term provided by | | |
| | | HandPostureTypeCS. | | |
| | chirality | Describes whether the hand of interest is | | |
| | | a left hand or a right. The value of | | |
| | | “Right” describes that the hand is a right | | |
| | | hand and the value of “Left” describes | | |
| | | that the hand is a left hand. | | |
| HandGesture | capturedTimeStamp | Describes the time (in milliseconds | | |
| | | relative to the epoch) at which a user | | |
| | | interaction was captured | | |
| | userId | Describes an index referencing the user | | |
| | | who is generating AUI patterns. | | |
| | sType | Describes the label of a hand gesture | | |
| | | pattern as a reference to a classification | | |
| | | scheme term provided by | | |
| | | HandGestureTypeCS. | | |
| | chirality | Describes whether the hand of interest is | | |
| | | a left hand or a right. The value of | | |
| | | “Right” describes that the hand is a right | | |
| | | hand and the value of “Left” describes | | |
| | | that the hand is a left hand. | | |

Referring to Table 4,

(1) A Point may be defined as the first event type. The Point is context information and may use the capturedTimeStamp and the Position. The capturedTimeStamp is the information showing the time when an interaction of the user was captured (the capturedTimeStamp has the same meaning hereafter and is not described in other event types) and the Position shows the 2D or 3D position information in the coordinates on a screen.

(2) A Line may be defined as another event type. As the context information for defining the Line, the capturedTimeStamp, position, timeStamps, averageVelocity, and maxAcceleration may be used as sentence elements. The position means the 2D or 3D coordinate information of two points in a line, the timestamps means the start time information when the line was drawn, the averagevelocity means the average velocity information while the line is drawn, and the maxAccelation means the maximum acceleration information while the line is drawn.

(3) A Rect may be defined as another event type. As the context information for defining the capturedTimeStamp, and position, timeStamps may be used as sentence elements. The position means the 2D or 3D coordinate information of the corner points of a rectangle and the timestamps means the time information when the corners were drawn.

(4) An Arc may be defined as another event type. As the context information for defining the Arc, the capturedTimeStamp, position, timeStamps, averageVelocity, and maxAccelation may be used. The position means the information on the drawing-start position and the drawing-end position of an arc and the 2D or 3D coordinate information showing the center position of a virtual circle, the timestamps means the time information when the user's interaction started, and the averageVelocity means the average acceleration while the arc is drawn, and the maxAcceleration means the maximum angular acceleration information while the arc is drawn.

(5) A Circle may be defined as another event type. As the context information for defining the Circle, the capturedTimeStamp, position, timeStamps, averageVelocity, maxAccelaeration, and fvalue may be used. The Position means the original coordinate information of a circle, the timestamps means the time information when the circle started to be drawn, the averageVelocity means the average angular velocity while the circle is drawn, the maxAcceleration means the average angular acceleration while the circle is drawn, and the fValue means the radius information of the circle.

(6) A TouchPattern may be defined as another event type. As the context information for defining the TouchPattern, the capturedTimeStamp, position, sType, and fValue may be used. The position may be the position information where a touch is generated, the sType may be a label showing the kind of the touch, and the fValue may be value information that is necessary for the touch pattern.

(7) A SymbolicPattern may be defined as another event type. As the context information for defining the SymbolicPattern, the capturedtimeStamp, position, sType, and fValue may be used. The position may be the position information where a symbol is generated, the sType may be the label information showing the kind of the symbol, and the fValue may be the size information of the symbol.

(8) A HandPosture may be defined as another event type. As the context information for defining the HandPosture, the capturedtimeStamp, position, sType, and fValue may be used. The position may be the position information where a hand posture is generated, the sType may be the label information showing the kind of the hand posture, and the fValue may be the size information of the hand posture.

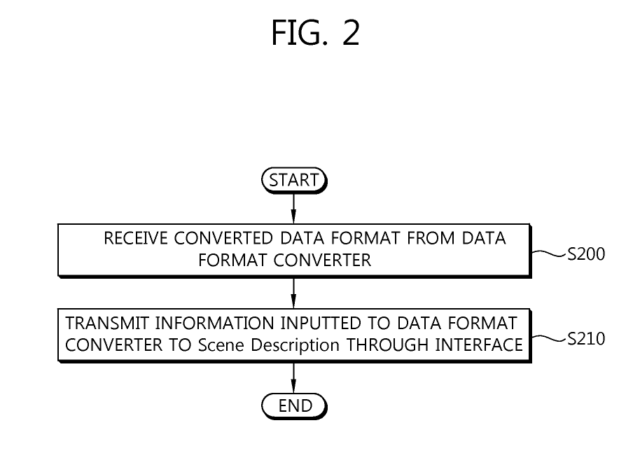

FIG. 2 is a flowchart showing a pattern information analysis method in an MPEG-U Part 1 according to an exemplary embodiment of the present invention.

Hereinafter, although implementing an interface for creating Scene Description information on the basis of the data inputted from the data format converter, an interface for receiving and transmitting the Scene Description information to the data format converter may be implemented, which is included in the scope of the present invention.

Referring to FIG. 2, a converted data format is inputted from the data format converter (step S200).

As described above, the motion information of the physical interaction information analyzed through the MPEG-U Part 2 and the MPEG-V Part 5 may be inputted to the data format converter. The data format converter performs data format conversion into an information format, which can be inputted to the MPEG-U Part 1, on the transmitted motion information of the physical interaction device.

The information inputted to the data format converter is transmitted to the Scene Description through a predetermined interface (step S210).

According to an exemplary embodiment of the present invention, the predetermined interface may be the MPEG-U Part 1. The information analyzed through the MPEG-U Part 1 may be used in the widget manager or the W3C application.

As in Table 2 described above, an interface for the widget manager may be defined. The pattern information and input information for expressing the pattern information as described in Table 2 may be created. That is, some pattern information in Table 2 may be used as the interface for expressing the motion information in the widget manager.

Further, it may be possible to transmit the motion information to the W3C application on the basis of the event information defined in Table 3, by defining the IDL interface as in Table 3.

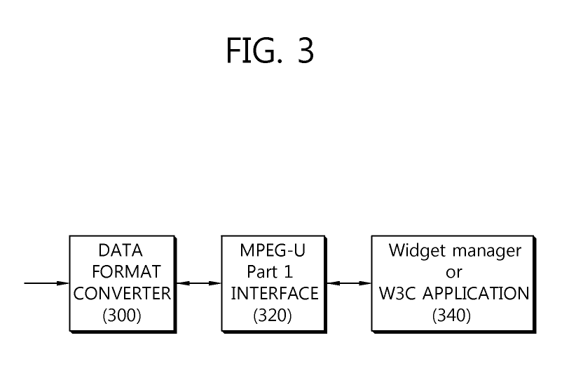

FIG. 3 is a conceptual diagram showing the motion between a widget manager and a physical device according to an exemplary embodiment of the present invention.

Hereinafter, although it is assumed that a physical signal is directly inputted to the interface between the widget manager and the physical device for the convenience of description, the information that is actually inputted to the interface may be information created by a signal generated from a physical device and additionally transmitted to the MPEG-V Part 5 interface and the data format converter.

Referring to FIG. 3, motion information generated by a user interface device (for example, information created by the data format converter 300) is inputted to an MPEG-U Part 1 interface 320. A motion of the widget may be implemented by transmitting the inputted motion information to a widget manager 340. For example, when a motion that indicates a specific portion on a touch mat is performed, the motion information may be analyzed through the MPEG U Part 1 interface 320 to be expressed on the widget 340. That is, the input motion information is analyzed on the basis of Table 2 defined in the interface and the corresponding information is transmitted to the widget manager 340. The widget manager 340 controls the motion of the widget on the basis of the motion information analyzed through the MPEG U Part 1 interface.

On the contrary, the MPEG U Part 1 interface may receive information created by the widget and transmit the inputted information to the data format converter 300. That is, the information generated by the widget may be transmitted to the data format converter 300 by performing the reverse motion of the motion described above.

As another exemplary embodiment, the same motion may be performed in the W3C application 340, as described above.

For example, the motion information generated by the user interaction device is inputted to the MPEG-U Part 1 interface 320. A motion of the widget may be implemented by transmitting the inputted motion information to the W3C application 340.

Although the present invention was described above with reference to exemplary embodiments, it should be understood that the present invention may be changed and modified in various ways by those skilled in the art, without departing from the spirit and scope of the present invention described in claims.

What is claimed is:

1. A method of implementing a user interface, comprising:
receiving AUI (Advanced User Interaction) pattern information; and
analyzing the inputted AUI pattern information on the basis of a predefined interface.

2. The method of claim 1, wherein the predefined interface is an interface that defines at least one piece of pattern information of Point, Line, Rect, Arc, Circle, SymbolicPattern, TouchPattern, and HandPosture.

3. The method of claim 1, wherein the predefined interface is an interface in which at least one of the pattern information is selectively used as pattern information of a widget manager, as predetermined predefined pattern information.

4. The method of claim 1, wherein the predefined interface is an interface in which at least one of the pattern information is selectively used a W3C application, as predetermined predefined pattern information.

5. A method of implementing a user interface, comprising:
receiving input information from a Scene Description; and
analyzing the input information provided from the Scene Description on the basis of a predefined interface, and inputting the analyzed input information to a data format converter.

6. The method of claim 5, wherein the predefined interface is an interface that defines at least one piece of pattern information of Point, Line, Rect, Arc, Circle, SymbolicPattern, TouchPattern, and HandPosture.

7. The method of claim 5, wherein the predefined interface is an interface in which at least one of the pattern information is selectively used as pattern information of a widget manager, as predetermined predefined pattern information.

8. The method of claim 5, wherein the predefined interface is an interface in which at least one of the pattern information is selectively used a W3C (World Wide Web Consortium) application, as predetermined predefined pattern information.

9. A user interface device comprising:
a data format converter that generates AUI (Advanced User Interaction) pattern information; and
an interface unit that analyzes the AUI (Advanced User Interaction) pattern information created through the data format converter on the basis of a predefined interface.

10. The method of claim 9, wherein the interface unit is an interface unit that defines at least one piece of pattern information of Point, Line, Rect, Arc, Circle, SymbolicPattern, TouchPattern, and HandPosture.

11. The method of claim 9, wherein the interface unit is an interface unit in which at least one of the pattern information is selectively used as pattern information of a widget manager, as predetermined predefined pattern information.

12. The method of claim 9, wherein the interface unit is an interface unit in which at least one of the pattern information is selectively used a W3C (World Wide Web Consortium) application, as predetermined predefined pattern information.
